(19) United States
(12) Patent Application Publication
(10) Pub. No.: US 2010/0050464 A1
(43) Pub. Date: Mar. 4, 2010

(54) Clothes dryer apparatus and method for de-wrinkling clothes with reduced condensation

(75) Inventors: Nicolas Krzelowski, St-Basile-Le-Grand (CA); Mathieu Lamy, Montreal (CA)

Correspondence Address: CRAIG WILSON, 2570 MATHESON BLVD. EAST, SUITE 211, MISSISSAUGA, ON, L4W 4Z3, CA

(73) Assignee: MABE CANADA INC., Burlington (CA)

(21) Appl. No.: 12/318,375

(22) Filed: Dec. 29, 2008

(30) Foreign Application Priority Data
Aug. 29, 2008 (CA) 2639251

(51) Int. Cl. F26B 7/00; F26B 11/02; F26B 21/08

(52) U.S. Cl. 34/380; 34/597; 34/557

(57) ABSTRACT

A clothes dryer has a drying drum with an airflow inlet and a motor for rotating the drum. A blower rotated by a fan motor flows air into, through, and out the drum. A refresh or touch-up de-wrinkle course is selected via a signal input on a control panel. Steam is supplied to the drum by a steam generating device, and heated air from a heater is supplied via the inlet. A controller operates the steam device and heater, in response to the course being selected, to supply to the drum a plurality of steam pulses of at least one first predetermined time and a heated air pulse after each steam pulse. Heated air pulses between steam pulses are intermediate pulses of at least one second predetermined time to reduce condensation in the dryer and the final pulse of heated air is of a duration to dry articles.

### FIELD OF THE INVENTION

The present invention relates to a clothes dryer having a wrinkle reducing or eliminating cycle wherein steam is supplied into the drum. More particularly, the present invention relates to a clothes dryer which pulses steam and hot air into the drum in order to de-wrinkle the articles within the drum with reduced condensation in the dryer.

### BACKGROUND OF THE PRESENT INVENTION

Various clothes dryer apparatuses and methods have been used in order to provide for the reduction or elimination of wrinkles in articles within the dryer. Such methods and apparatuses may comprise the selection by a user of a de-wrinkling course.

In U.S. Pat. No. 7,325,330 to Kim et al., a processor within the dryer determines whether a wrinkle-eliminating course is selected. The clothes dryer comprises a heater for heating the air supplied to the dryer drum. The clothes dryer further comprises a steam generating device. When wet clothes are placed into the drum and the dryer is activated, the drum rotates to uniformly mix and dry the clothes as hot air supplied to the drum which evaporates the moisture in the clothing articles. Once the clothes have dried, and if the wrinkle-eliminating course has been selected, the dryer may operate to eliminate wrinkles in the clothes. During the wrinkle-eliminating course, a microcomputer controls the operation of the dryer so that hot air heated to a predetermined temperature for a predetermined time is supplied to the drum after steam is supplied for a predetermined time to eliminate wrinkles in the clothes. The dryer drum rotates during the wrinkle eliminating course. The wrinkle-eliminating course may be selected independently of any other course in order to remove wrinkles from the clothes without having to wash or sterilize them beforehand. In this instance, hot air is supplied to the clothes to eliminate dust and then steam is supplied to the clothes, from which the dust was eliminated, to eliminate wrinkles in the clothes.

In JP Patent 6,233,898 a clothes dryer has a steam function that eliminates creases or wrinkles in the clothing. A single controller is responsive to a steam course selection to remove creases from the clothing. The controller first determines whether a crease eliminating course has been selected and, if yes, then controls the dryer operation to provide steam followed by ambient air, both for a predetermined time.

In U.S. Pat. No. 3,670,425 to Benjamin et al. a clothes drying cabinet comprises a switch that starts a timer controller that permits steam to enter the cabinet to steam clothing within the cabinet for a first predetermined period of time. After this, the controller controls a heating element and blower to introduce hot air into the cabinet for a second predetermined time to remove wrinkles from the clothing.

U.S. Pat. No. 5,305,484 to Fitzpatrick et al. teaches a clothes hanging cabinet that has a steam period followed by a heated air period to eliminate wrinkles. During the steaming period, heated air is intermittently supplied into the cabinet to reduce the formation of condensation on the interior of the cabinet. Hence, this apparatus supplies both steam and heated air at the same time during the steam period. However the application of both heated air and steam into a rotating dryer drum at the same time requires considerable energy to be drawn by the rotating dryer due to the energization of the heating elements for both the hot air and steam boiler. Due to safety considerations the application of steam and hot air at the same time is not presently permitted in some markets.

In some instances, when steam is supplied to a rotating dryer drum, it may condense to form water droplets that deposit in the dryer and on the clothing articles, which is unsatisfactory. Thus, it is desirable to produce a clothes dryer machine and method which would reduce or minimize the build-up of condensed steam within the dryer drum and cabinet during a wrinkle elimination cycle.

### BRIEF DESCRIPTION OF THE INVENTION

The present invention relates to a clothes dryer having a wrinkle reducing or eliminating cycle wherein steam is supplied into the drum. More particularly, the present invention relates to a clothes dryer which pulses steam and hot air into the drum in order to de-wrinkle the articles within the drum with reduced condensation in the dryer.

The clothes dryer comprises a cabinet and a drum located in the cabinet within which clothing articles to be dried are placed. The drum comprises an air flow inlet. A motor located in the cabinet rotates the drum about an axis. A blower flows air into, through, and out of the drum. The dryer further comprises a signal input for selecting a de-wrinkle course. A heater heats air that is supplied to the drum via the air flow inlet. A steam generating device generates steam to be provided to the drum such that generated steam may be released into the drum. A main controller controls the operation of the steam generating device and the heater in response to the de-wrinkle course being selected wherein the controller operates the steam generating device and the heater to provide a plurality of pulses of steam of at least one first predetermined time and a pulse of heated air is supplied to the drum after each steam pulse. Each pulse of heated air between steam pulses is an intermediate pulse of at least one second predetermined time to reduce condensation in the dryer and the pulse of heated air after the last steam pulse is a final pulse of a duration to dry the clothing articles.

For the purposes of the present invention, the term “pulse” of steam or heated air is intended to mean an application of steam or heated air, respectively, for a time duration and does not mean that the amplitude of steam or heated air remains constant over the time duration. Further, the steam pulses and the heated air pulses are provided at mutually exclusive times whereby the steam generator and heater are not actuated at the same time thereby limiting energy drawn by the dryer.

The de-wrinkle course may be a selected one of an operational course for eliminating wrinkles after a drying operation has been completed and an independent course for eliminating wrinkles in the clothing articles. The duration of the final pulse may be a selected one of a predetermined time and a duration according to the dried state of the clothing articles.

In one embodiment of the invention, the dryer is an electric dryer and the motor comprises a reversible motor able to rotate the drum in a first rotation direction and in a second rotation direction opposite the first. The main controller is operable to energize the motor to rotate the drum in the first direction for a first rotation period and then de-energize the motor to reduce drum angular velocity, and then energize the motor to rotate the drum in the second rotation direction for a second rotation period. The main controller alternates drum rotation between the first and the second rotation direction throughout the de-wrinkle course, reducing drum angular velocity prior to changing rotation direction.

In one embodiment of the invention, the clothes dryer further comprises a fan motor for rotating the blower. The fan motor is independently operable of the motor for rotating the drum. The main controller, in response to the de-wrinkle course being selected, operates the fan motor and the blower in an on state to supply air to the drum during pulsing of heated air. The main controller operates the fan motor and blower in an off state during the steam pulsing whereby no air is supplied to the drum during steam pulsing. The main controller may operate the fan motor and blower in the on state during the cool down cycle to supply ambient air. In an alternative embodiment it is envisaged a single motor may be used to rotate the drum and the blower fan and the rotation of the drum and blower motor being reduced during the steam pulsing. In still yet another embodiment, a single motor may be utilized to rotate both the drum and the blower fan with a clutch coupling the blower fan to the motor whereby the main controller operates the clutch to disengage coupling between the motor and blower fan during a steam cycle.

In another embodiment of the present invention, there is provided a method for reducing or eliminating wrinkles in clothing articles in a clothes dryer. The method comprises the steps of determining that a de-wrinkle course has been selected; supplying a plurality of pulses of steam of at least one first predetermined time to the clothing articles in response to it being determined that a de-wrinkle course has been selected; and supplying a pulse of heated air to the clothing articles after each steam pulse where each pulse of heated air supplied between steam pulses is an intermediate pulse of at least one second predetermined time to reduce condensation in the dryer and the pulse of heated air after the last steam pulse is a final pulse of a duration to dry the clothing.

### BRIEF DESCRIPTION OF THE DRAWINGS

For a better understanding of the nature and objects of the present invention reference may be had by way of example to the accompanying diagrammatic drawings in which:

FIG. 1 is a perspective view of an exemplary clothes dryer that may benefit from the present invention;

FIG. 2 is a side sectional view of an exemplary clothes dryer that may benefit from the present invention;

FIG. 3 is a front view of the control panel of the dryer;

FIG. 4 is a diagram showing the control system for the clothes dryer operation;

FIG. 5 is a flowchart illustrating a method for eliminating or reducing wrinkles in clothing articles using steam in accordance with the present invention;

FIG. 6 is a flowchart illustrating another method for eliminating or reducing wrinkles in clothing articles using steam in accordance with the present invention;

FIG. 7 is a diagram showing a refresh cycle in accordance with the present invention;

FIG. 8 is a diagram showing an exemplary de-wrinkle cycle in accordance with the present invention; and,

FIG. 9 is a diagram showing an exemplary electrical heater assembly and support for use with the present invention.

### DETAILED DESCRIPTION OF THE INVENTION

The present invention relates to a clothes dryer having a wrinkle reducing or eliminating cycle wherein steam is supplied into the drum. More particularly, the present invention relates to a clothes dryer which pulses steam and hot air into the drum in order to de-wrinkle the articles within the drum with reduced condensation in the dryer.

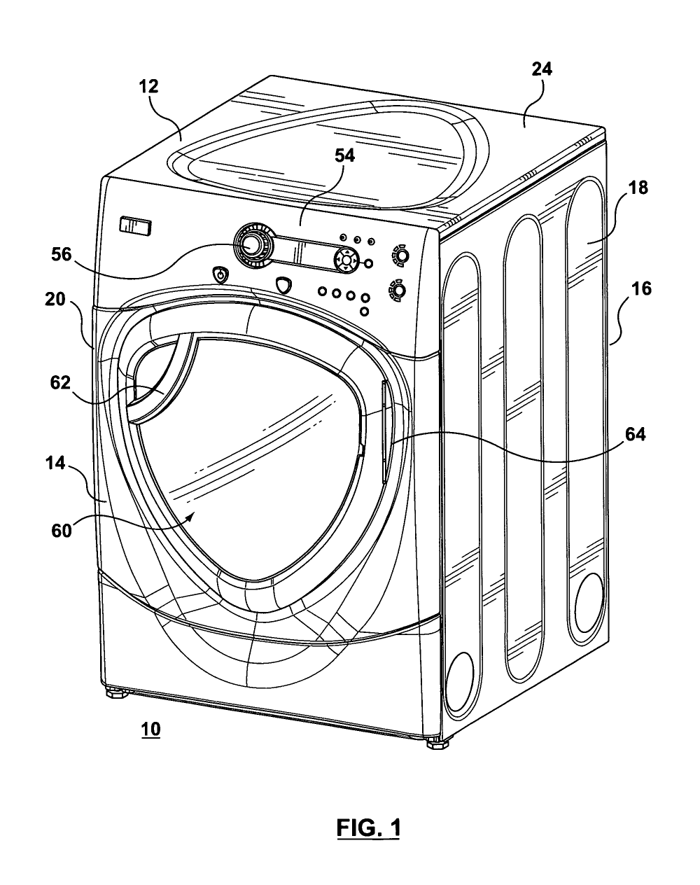

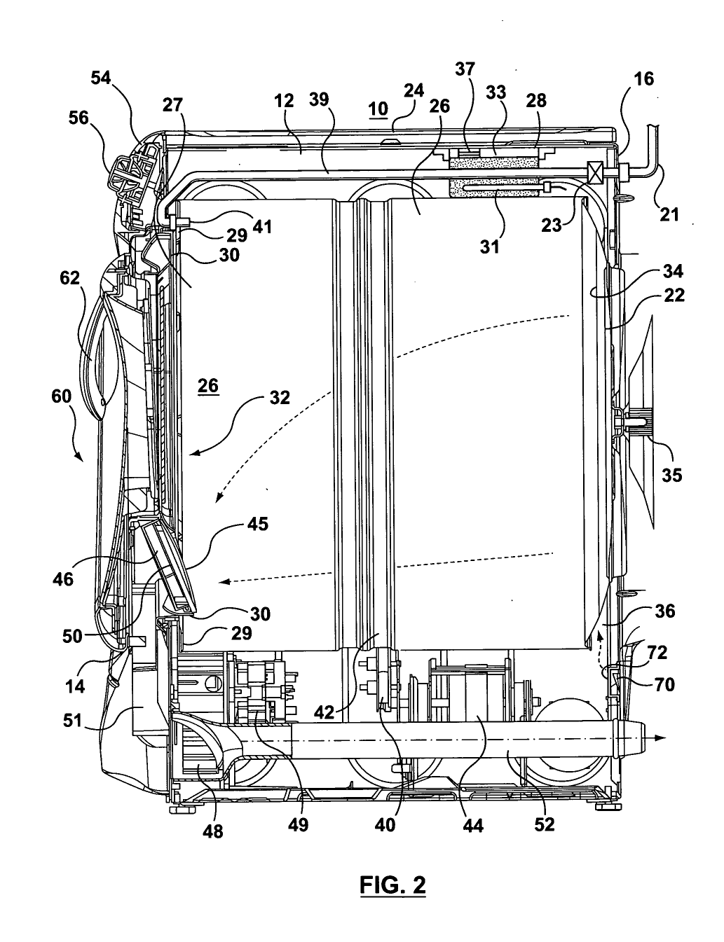

FIGS. 1 and 2 show perspective and side sectional views of exemplary clothes dryer 10 that may benefit from the present invention. The clothes dryer 10 includes a cabinet or a main housing 12 having a front panel 14, a rear panel 16, a pair of side panels 18 and 20 spaced apart from each other by the front and rear panels, and a top cover 24. Within the housing 12 is a drum or container 26 mounted for rotation around a substantially horizontal axis. A motor 44 rotates the drum 26 about the horizontal axis through, for example, a pulley 40 and a belt 42. In an alternative embodiment wherein the dryer 10 is an electric dryer, the motor 44 may comprise reversible motor able to rotate the drum in a first rotation direction and in a second rotation direction opposite the first. The drum 26 is generally cylindrical in shape, has an imperforate outer cylindrical wall 28, and has an open end 27 that typically comprises a metal ring 29 of reduced diameter that is attached by welding to the drum for reducing the diameter of the opening of the drum 26 to match a front bulkhead structure 30. The bulkhead structure 30 further defines an access opening 32 into the drum 26. The access opening 32 is shown closed by a window or port-hole like door 60. Door 60 has a handle 62 for pivotally opening the door about hinge 64. Access opening 32 has a reduced area across it as compared to the area across the open end 27 of the drum 26. Clothing articles and other fabrics are loaded into the drum 26 through the access opening 32. A plurality of tumbling ribs (not shown) are provided within the drum 26 to lift the articles and then allow them to tumble back to the bottom of the drum as the drum rotates. The drum 26 includes a rear wall 34 rotatably supported within the main housing 12 by a suitable fixed bearing 35. The rear wall 34 includes a plurality of holes (not shown) that receive hot air that has been heated by a heater such as electrical heating elements (not shown) in the heater housing 22. The housing 22 receives ambient air via an inlet 36. Although the exemplary clothes dryer 10 shown in FIG. 1 is an electric dryer it could just as well be a gas dryer having a gas burner.

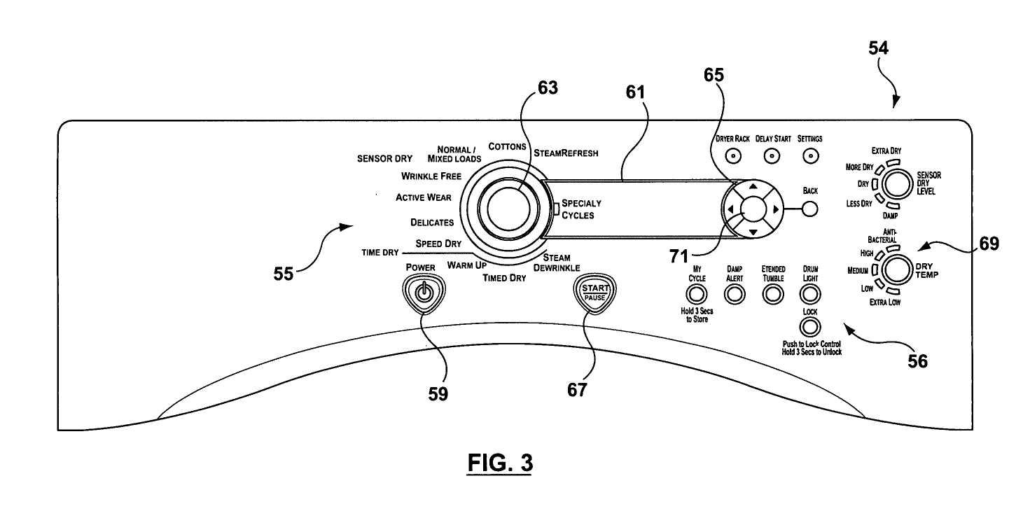

Referring to FIG. 3, the dryer has a user interface and display panel or control panel 54 with touch and/or dial controls 56 whereby a user can control the operation of the dryer 10 and which further allows for monitoring progress of respective cycles of operation of the dryer 10. The control panel 54 further comprises a heat setting selector 69 that allows the user to select a temperature setting based on the delicateness of the clothes to be dried. Such temperature settings are known as normal, permanent press and delicate, for example. In the preferred embodiment, the control panel 54 comprises a signal input 55 which may comprise a power button 59 for activating the display 61, a central knob 63 rotatable to select the desired course, toggle buttons 65 for selecting the number of garments or the load size, and an enter or start button 67 for starting the selected cycle.

In the embodiment shown, heated or ambient air is drawn from the drum 26 by a blower or fan 48 which is also driven by a second motor or fan motor 49 in the embodiment shown in FIG. 2. The fan motor 49 is independently operable of the motor 44 for rotating the drum 26. In an alternative embodiment, motor 44 could be used to drive blower fan 48 thereby eliminating the need for fan motor 49. During dryer operation, air passes through a grill 45 and screen filter 46. Grill 45 keeps clothing articles tumbling in the drum 26 from contacting the filter 46 and touching the lint trapped by the filter 46 within the trap duct 50. As the air passes through the screen filter 46, it flows through lower duct portion 51 and is drawn by blower wheel 48 attached to fan motor 49 out of the clothes dryer through an exhaust duct 52. In this embodiment, the drum 26 is in air flow communication with the trap duct 50 whose lower duct portion 51 has an outlet that is in air flow communication with the blower fan 48 and the exhaust duct 52.

In FIG. 2, a steam generating device 33 for supplying steam to the dryer drum 26 is fastened to the dryer cabinet 12. Water is supplied to the steam generating device 33 from a water supply line or pipe 21, which is connected with a water source (not shown in the figures). A water supply valve 23 is installed in the water supply pipe 21 for controlling the supply of water into the steam generating device 33. From the valve 23, the water supply pipe 21 passes through the steam generating device 33. The steam generating device 33 includes a U-shaped steam heater 31 installed therein for heating the water passing therethrough to convert it into steam. A temperature sensor 37 is installed on the outer surface of the steam generating device 33 for sensing the temperature of the steam generating device 33 and a steam supply line or pipe 39 extending from the steam generating device 33 toward the dryer drum 26 for supplying steam to the dryer drum 26. The outlet end of the steam supply pipe 39 may comprise a spray nozzle 41 for spraying the steam onto the clothing articles contained in the drum 26.

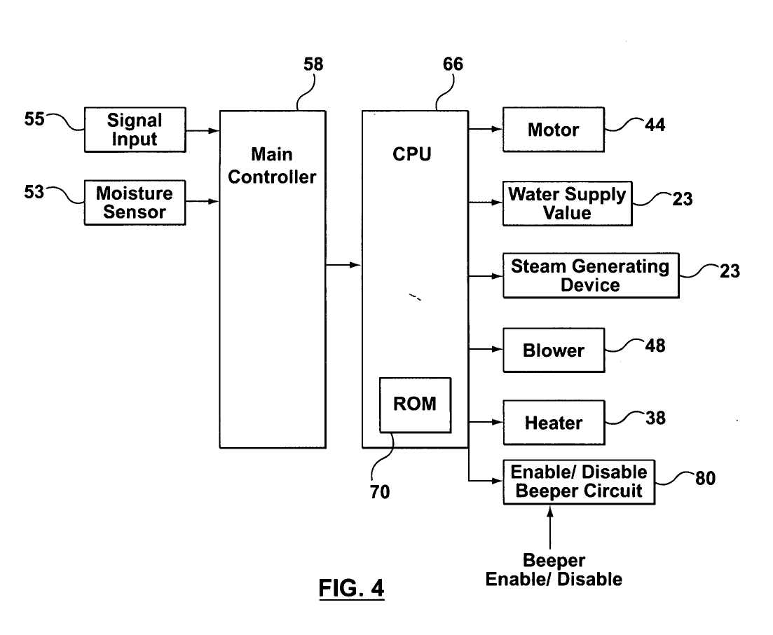

FIG. 4 is a block diagram of a system for controlling the dryer 10 having the steam generating device 33 in accordance with the present invention. The system comprises signal input 55 and a moisture sensor 53. Values generated and output by the moisture sensor 53 and the signal input 55 are received by controller or main controller 58. These values are used by the main controller 58 to regulate the drying cycle and the de-wrinkle course. The signal input 55 serves to provide to main controller 58 operating data such as de-wrinkle course selection as well as the number of garments in the load or the load size, via the controls 56. The moisture sensing unit 53 serves to detect the temperature and humidity of the clothes, thereby sensing the dried state of the clothes. The moisture sensor 53 is further discussed hereinbelow.

Moisture sensor 53 is used to communicate to the main controller 58 the level of moisture content in the load of clothing articles in the drum 26. Moisture sensor 53 typically comprises a pair of spaced-apart electrodes and further comprises circuitry for generating and outputting a voltage sensor value to the main controller 58 based on the electrical or ohmic resistance of the load. The moisture sensor 53 is located on the front interior wall of the drum and alternatively may be mounted on the rear drum wall 34. Articles tumbling in the dryer drum 26 will come into contact with the moisture sensor 53. The moisture sensor 53 may provide a continuous representation of the moisture content of the load in a range suitable for processing by main controller 58. It will be appreciated that the signal indicative of the moisture content need not be a voltage signal and, through the use of a voltage-controlled oscillator, a moisture signal could be chosen as having a frequency that varies proportionally to the moisture content of the articles instead of a signal whose voltage varies proportionally to the moisture content of the articles. When wet clothes contact the moisture sensor 53, the resistance across the voltage sensor is low. When dry clothes contact the moisture sensor 53 electrodes, the resistance across the voltage sensor is high and is typically indicative of a dry load.

Still with reference to FIG. 4, the main controller 58 further comprises processor (CPU) and controls the operation of the dryer according to one or more processing modules stored in association with or on the CPU 66 in a suitable memory device, such as read only memory (ROM) 70. It will be appreciated that the memory device need not be limited to ROM being that any memory device, such as an erasable programmable read only memory (EPROM) that stores instructions and data will work just as effectively. In the case of the selected de-wrinkle course, the main controller 58 communicates with the CPU 66 which sends respective signals to the motor 44, the blower 48, the heater 38, the steam generating device 33 and the water supply valve 23 to provide a plurality of pulses of steam wherein an intermediate pulse of heated air is supplied to the drum after each steam pulse. It should be understood that the main controller 58 can adjust the duration and/or the number of pulses in the de-wrinkle cycle as a function of load size or the number of garments inputted by the user using controls 56. It should also be understood that the main controller 58, in one embodiment, may operate the heater 38 to provide heated air to the drum 26 prior to the first steam pulse so as to pre-heat the drum and garments.

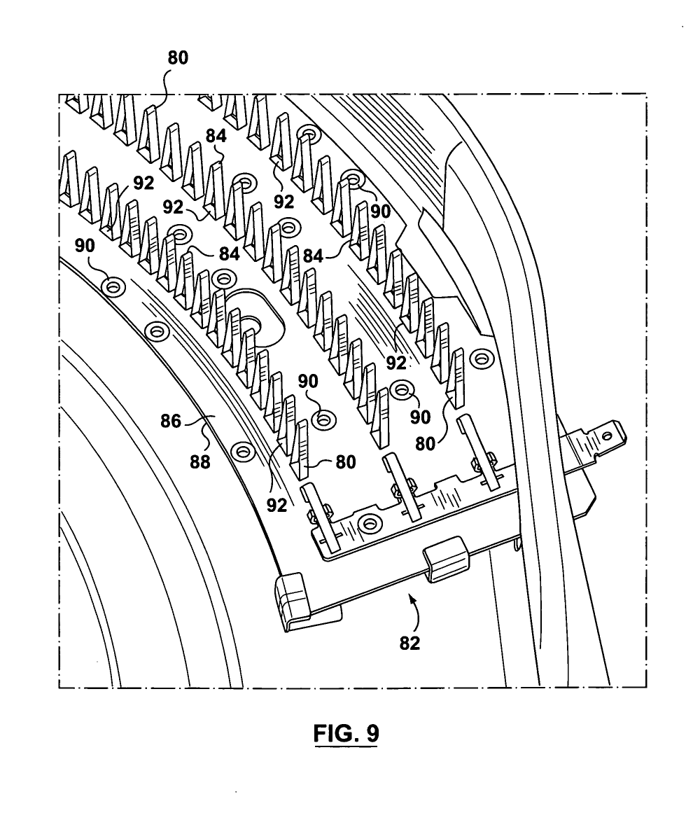

Preferably, when the heater assembly 38 comprises an electrical heating element, the electrical heating element used is one that is robust against current leakage in a humid environment inherent to a steam application. One such electrical heating element comprises a looped heating element supported by a mica support comprising one or more support plates as disclosed in CA patent application 2,594,248 published , herein incorporated by reference. FIG. 9 shows an embodiment of the heater assembly 38 wherein an electric heating element comprises a looped heating element 80 supported by a mica support 82. In the embodiment shown, the support 82 is arcuate in shape and comprises upper and lower or first and second overlapping mica support plates 86, 88 which may be secured together by rivets 90. The construction of the support plates 86, 88 may comprise any suitable insulating ceramic material and preferably is a mica material. The looped heating element 80 may comprise loop portions 84 of any configuration, but preferably are in a “V” or “U” shape. The upper mica plate 86 comprises three series of apertures 92, each extending in an arc along the mica plate 86. Along each of these arcs, the heating element 80 extends. The heating element 80 has a flat portion (not shown) that is sandwiched between the plates 86, 88 as well as a loop portion 84 which passes through the apertures 92 and extends away from the plates 86, 88. The heating elements 80 are connected to a source of electrical supply (not shown) via terminals. When electrical energy is fed via the terminals to the heating elements 80, the elements dissipate and warm air passes over and around the elements 80. The warm air then passes via the drum 26 to dry the clothing articles.

In the preferred embodiment of the invention, the user may select one of a plurality of de-wrinkle courses. Preferably, the selectable de-wrinkle courses include a refresh course and a touch-up course, although other embodiments may be conceived within the scope of the present invention. The refresh course is selected in instances where the user wishes to de-wrinkle a relatively small number of clothing articles independently of a dry cycle. If the user has a few clothing articles that require de-wrinkling, the articles may be placed into the dryer to have the wrinkles removed or reduced. For the refresh cycle, the user is prompted to input the number of garments placed into the dryer. In the present embodiment of the refresh course, the user inputs, using the toggle buttons 65 and select button 71, a number of garments ranging from 1 to 5 for de-wrinkling. It should be understood that other embodiments may permit a greater or lesser number of garments to be input. The touch-up course may occur following a previous dryer operation, such as a dry cycle, or may occur as an independent course selected by the user. For example, if the user has left clothing in the dryer for an extended period after a previous dryer operation, the clothing may have become wrinkled and require de-wrinkling. For the touch-up course, the user is prompted to input, via the toggle buttons 65 and select button 71, the load size placed into the drum. In the preferred embodiment, the user inputs one of a small, medium, or large load size to be de-wrinkled. In an alternative embodiment, load size may be input by weight. For example, the user may select a load size of 2 lbs., 4 lbs., 6 lbs. or 8 lbs. It should be understood that other embodiments may permit fewer or more load size options to be available to the user. It should also be understood that the pulses of steam followed by the pulses of heated air are an important aspect of the present invention. The alternation of steam and heated air provides the advantage wherein condensation is not permitted to accumulate over a lengthy steam period and power is not simultaneously provided to the air heater and steam heater or boiler. If the steam provided by a steam pulse condenses, the condensation is substantially reduced by the subsequent heated air pulse. The operation of the de-wrinkle courses shall be further discussed herein with reference to specific methods in accordance with the present invention.

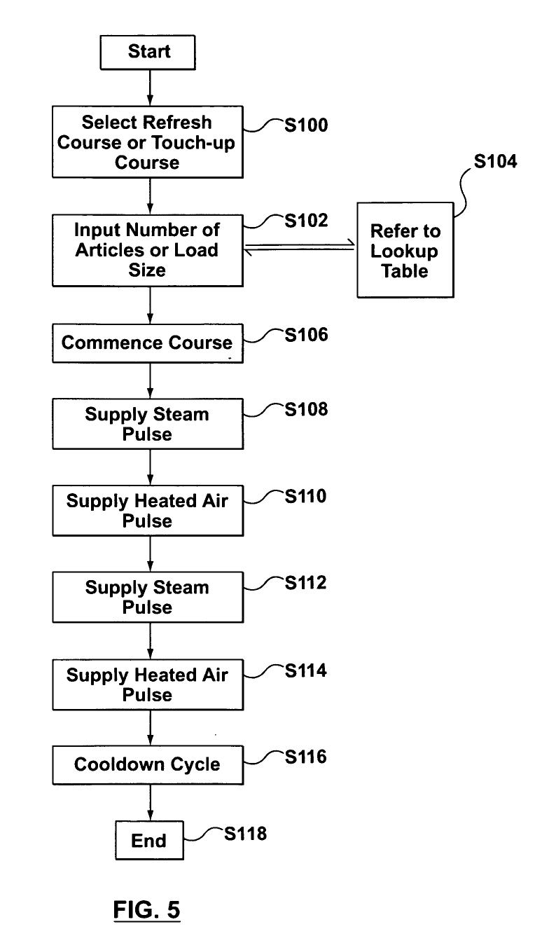

Referring now to the flow chart drawing of FIG. 5 to FIG. 7, there is illustrated one embodiment of the method of eliminating or reducing wrinkles in clothing articles using steam in accordance with the present invention. In FIG. 5, the flow chart shows the operation of the main controller 58. The user activates a display 61 using power button 59. The user is then prompted to select a de-wrinkle course. In the preferred embodiment the user may select, using control panel 54, one of the refresh course and touchup course, as shown at step S100. The user is then prompted to input the number of garments, for the refresh course, or the load size, for the touchup course at S102. Using these inputs the main controller 58 utilizes the CPU 66 to refer to the lookup table stored in the ROM 70 to retrieve the predetermined pulse times in duration of the number of pulses for the selected de-wrinkle course as shown at steps S104. The user then presses the enter button at step S106 and commences the de-wrinkle course. The controller then moves the dryer through the steps S108 through S114 whereby steam pulses of lookup predetermined duration are supplied at steps 108 and subsequently at step S112. An intermediate heated air pulse is provided at step S110 and is of the duration to reduce condensation in the dryer. After the second steam supply pulse at S112, a final heated air pulse is supplied at S114. In FIG. 5 the final supplied hot air pulse S114 is used to dry the clothing in the drum and complete the removal of wrinkles from the clothing. At step S116 the drum goes into a cool down cycle where ambient air is blown into the drum to cool the clothing. S118 signifies the end of the de-wrinkle operation. Although this flow chart of FIG. 5 shows the use of steam and heated air being supplied twice each, it should be understood that one or more additional steam and heated air pulses steps may be included depending on the information received from the lookup table based on the number of garments or load size provided by the user. The greater selected number of garments or greater selected load size may require one or more additional steam and heated air pulses to complete the de-wrinkling operation. Further it should be understood that the times for each of the steam and heat pulse may be variable. That is the time for the first heat pulse need not be the same as the time for the second heat pulse. This applies equally to the steam pulses wherein the times of each of the steam pulses may be different. Therefore in FIG. 5, S114 may be of the duration that is the same as, shorter than, or longer than the previous intermediate heated air pulse S110. The de-wrinkle course is completed once the final heat air pulse S114 is finished. The heater 38 is de-energized after the final heated air pulse and the dryer enters a cool down cycle as shown at step S116 wherein ambient air 78 is supplied to the drum and the articles are tumbled in the drum for a period until excessive heat has been removed from the load. Following the cool down cycle, the CPU 66 may de-energize the motor 44 thus ending dryer operation as shown at step S118. Preferably the dryer drum 26 tumbles continuously throughout the de-wrinkle course and for de-wrinkle courses of shorter time frame the dryer drum 26, may continue to tumble for a predetermined time after de-wrinkling is completed whereby the articles will tumble in the dryer drum until removed by the user. As the drying cycle is shut off, the controller 58 may activate a beeper or other signaling device (not shown in the figures), via enable/disable beeper circuit 80 (FIG. 4), to indicate the end of de-wrinkling course selection cycle to the user.

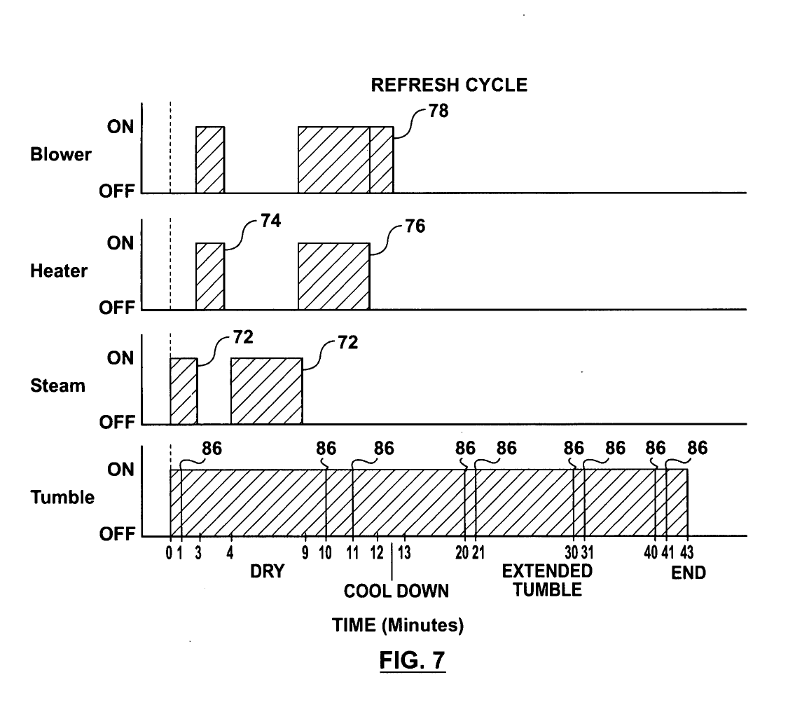

Referring to FIG. 7, the flow chart of FIG. 5 commences at time zero and is shown that the dryer to continue to tumble throughout all pulses of steam 72 and heated air 74, 76. The dryer continues to tumble for a cool down cycle 78 and even for an extended tumble time after the end of the cool down cycle. Initially steam is provided at time zero as shown by pulse 72 of a duration that is shown to be in the order of two minutes. Subsequent to this a heated air pulse at 74 is provided for one minute as well as the application of the blower fan to move the heated air through the dryer drum. After this, a pulse of steam is supplied at 72 between minutes four through nine. After the ninth minute, a final pulse 76 of heated air is supplied for a predetermined time of approximately three minutes in order to dry the small load of clothing and thereafter from minutes twelve to thirteen at 78 ambient air is blown through the dryer drum in cool down. The pulse duration indicated in FIG. 7 is for a refresh course selection cycle wherein a small number of garments has been entered into the signal input device 55 of controller 58. It should be noted that during each steam pulse, no air is blown by the blower through the drum because the dryer preferably utilizes one motor for tumbling and one motor for operating the blower. In an alternative embodiment instead of steam it is envisaged that a fine heated water mist may be sprayed into the dryer drum which mist turns to steam when coming into contact with the warm air or heated clothing in the drum.

It should be understood that in an embodiment comprising an electric dryer, the direction in which the dryer drum tumbles may change during the de-wrinkle cycle. The main controller 58, during the de-wrinkle cycle, may operate the motor 44 to rotate the drum in a first predetermined direction for a first rotation period and then to rotate in a second predetermined direction opposite the first predetermined direction for a second rotation period. Preferably, the main controller 58 operates the motor 44 to repeatedly alternate between the first and the second predetermined directions of drum rotation until the end of the de-wrinkle cycle. Prior to each change in direction, the controller 58 will de-energize the motor 44 to reduce the angular velocity of the drum 26. In the embodiment of FIG. 7, there is shown drum rotation direction changes 86. During the first minute of the de-wrinkle cycle, the controller 58 operates the motor 44 to rotate in the first rotation direction. After the first minute of the de-wrinkle cycle, the controller 58 de-energizes the motor 44 to reduce the angular velocity of the drum 26 and then energizes the motor 44 to rotate in the second rotation direction for nine minutes. After nine minutes rotating in the second rotation direction, at minute ten, the controller 58 de-energizes the motor 44 to again reduce drum angular velocity and then energizes the motor 44 to once again change rotation directions to rotate in the first rotation direction for one minute, to minute 11. This 1 minute-9 minute pattern for alternating rotation direction continues throughout the refresh cycle and ends when the motor 44 is de-energized at the end of the cool down cycle to stop drum tumbling. It should be understood that, although only a refresh cycle is shown in FIG. 7, direction changes may also apply during any of the de-wrinkle operations within the scope of the present invention. Further, although the embodiment of FIG. 7 shows a specific time-based pattern of direction changes 86, it should be understood that direction changes 86 may occur at any time during a de-wrinkle cycle. In an alternate embodiment for a gas dryer, the direction of drum rotation does not reverse during the de-wrinkle cycle.

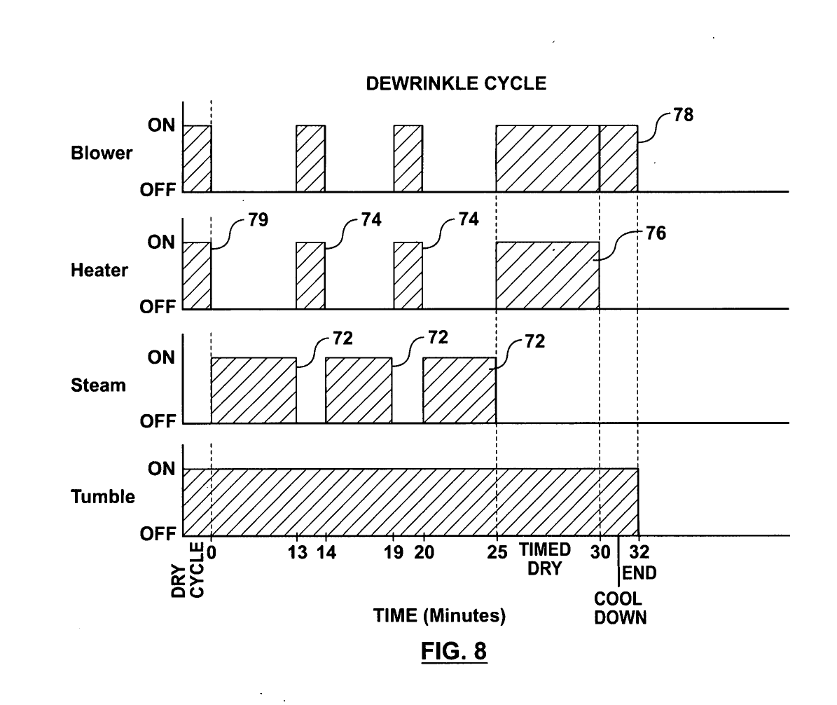

Referring to FIG. 8, there is shown anther pulse duration figure similar to that of FIG. 7 however FIG. 8 is for a de-wrinkle cycle for a touchup course where the clothing may have been left in the dryer drum over night. In this instance, after the zero minute mark, steam is first introduced for a period of about thirteen minutes at step 72. This first pulse of steam is then followed by an intermediate pulse 74 of heated air between minutes thirteen and fourteen as shown by the activation of the heater and the blower. This pulse application of heated air between thirteen and fourteen is an intermediate pulse and is provided for the purposes of reducing condensation within the dryer. Thereafter between minutes fourteen and nineteen another pulse 72 of steam is applied. Thereafter, between minutes nineteen and twenty another intermediate pulse of hot air or heated air 74 is provided at the same time with the blower application. Again the intermediate pulse of heated air is provided to remove condensation from the dryer drum. Thereafter between minutes twenty and twenty-five a third steam pulse 72 is applied to the dryer drum. Thereafter between minutes twenty-five and thirty, the heater is activated to provide a final pulse 76 of heated air at the same time as the blower. This final pulse 76 is of a five minute duration and is used as a time dry cycle of a predetermined duration. Thereafter a two minute cool down occurs at 78 whereby the blower is only activated to blow ambient air through the dryer. At this point the de-wrinkle cycle ends. No further tumbling is provided after the thirty-two minute period since the length of duration of the touchup is considerably longer than that of a refresh mode shown in FIG. 7. It should be understood that there may be optionally provided, prior to the zero minute, an initial heat pulse 79 to preheat the dryer drum and clothing within the dryer prior to the application of the first steam pulse 72. This involves operating the blower and heater for a predetermined time.

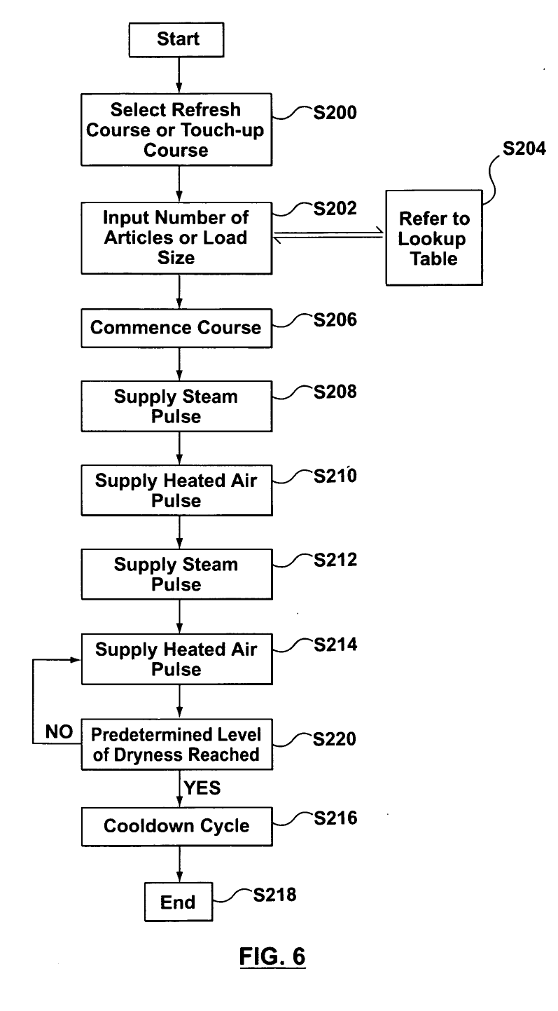

Referring to FIG. 6, this Figure is substantially the same as that shown in FIG. 5 wherein the user selects a refresh course or touchup course at S200 and then inputs the number of articles or load size at S202. The controller then looks up in the lookup table at step S204 the predetermined pulses and pulse durations required for each of the supplied steam pulses S208, S212 and supply of heated air at S210. This embodiment differs in that the supply of heated air in the final pulse at S214 is determined when a predetermined level of dryness is reached at S220 as indicated by the main sensor 53 inputting its information into the main controller 58. After the clothing has reached a predetermined dry state as provided by S220 and S214, the dryer goes into a cool down state at S216 and the dryer shuts down at S214 at the end of the cool down cycle.

While the invention has been described in terms of various specific embodiments, those skilled in the art will recognize that the invention can be practiced with modifications within the spirit and scope of the present invention as disclosed herein.

What is claimed is:

1. A clothes dryer comprising:
a cabinet;
a drum located in the cabinet within which clothing articles to be dried are placed, the drum comprising an air flow inlet;
a motor located in the cabinet for rotating the drum about an axis;
a blower for flowing air into, through, and out of the drum;
a signal input for selecting a de-wrinkle course;
a heater for heating air supplied to the drum via the air flow inlet;
a steam generating device for generating steam to be provided to the drum such that generated steam may be released into the drum;
a main controller for controlling the operation of the steam generating device and the heater in response the de-wrinkle course being selected, wherein the controller operates the steam generating device and the heater to provide a plurality of pulses of steam of at least one first predetermined time and a pulse of heated air supplied to the drum after each steam pulse wherein each pulse of heated air between steam pulses is an intermediate pulse of at least one second predetermined time to reduce condensation in the dryer and the pulse of heated air after the last steam pulse is a final pulse of a duration to dry the clothing articles.

2. The clothes dryer of claim 1 wherein the de-wrinkle course may be a selected one of an operational course for eliminating wrinkles after a drying operation has been completed and an independent course for eliminating wrinkles in the clothing articles.

3. The clothes dryer of claim 1 wherein the duration of the final pulse is a selected one of a predetermined time and a duration according to the dried state of the clothing articles.

4. The clothes dryer of claim 1 wherein the steam is supplied to the dryer drum via a steam supply line in communication with the steam generating device and with the drum.

5. The clothes dryer of claim 1 wherein the dryer is an electric dryer comprising an electric heater having a mica support with a looped heating element.

6. The clothes dryer of claim 5 wherein the motor comprises:
a reversible motor able to rotate the drum in a first rotation direction and in a second rotation direction opposite the first;
the main controller operable to energize the motor to rotate the drum in the first rotation direction for a first rotation period and then de-energize the motor to reduce drum angular velocity, and then energize the motor to rotate the drum in the second rotation direction for a second rotation period; and
the main controller alternating drum rotation between the first and the second rotation direction throughout the de-wrinkle cycle and reducing drum angular velocity prior to changing rotation direction.

7. The clothes dryer of claim 5 wherein the de-wrinkle course may be a selected one of an operational course for eliminating wrinkles after a drying operation has been completed and an independent course for eliminating wrinkles in the clothing articles.

8. The clothes dryer of claim 5 wherein the duration of the final pulse is a selected one of a predetermined time and a duration according to the dried state of the clothing articles.

9. The clothes dryer of claim 5 wherein the steam is supplied to the dryer drum via a steam supply line in communication with the steam generating device and with the drum.

10. The clothes dryer of claim 5 wherein, prior to the first steam pulse, the main controller operates the heater to supply heated air into the drum.

11. The clothes dryer of claim 5 further comprising a moisture sensor located within the drum for sensing moisture content of the articles and generating a moisture content value related thereto, wherein the main controller is operable with the moisture sensor whereby the main controller de-energizes the heater to terminate the final pulse of heated air once the moisture sensor detects, using the moisture content value, a predetermined level of dryness for the clothing articles.

12. The clothes dryer of claim 5 wherein after the final pulse, the main controller operates the dryer to enter a cool down cycle wherein the main controller operates the blower to supply ambient air to the drum and the motor to rotate the drum until the cool down cycle ends.

13. The clothes dryer of claim 5 further comprising:
a fan motor for rotating the blower, the fan motor being independently operable of the motor for rotating the drum;
the main controller in response to the de-wrinkle course being selected, operating the fan motor and the blower in an on state to supply air to the drum during pulsing of heated air; and
the main controller operating the fan motor and blower in an off state during the steam pulsing whereby no air is supplied to the drum during steam pulsing.

14. The clothes dryer of claim 12 further comprising:
a fan motor for rotating the blower, the fan motor being independently operable of the motor for rotating the drum;
the main controller in response to the de-wrinkle cycle being selected, operating the fan motor and blower in an on state to supply heated air to the drum during pulsing of heated air;
the main controller operating the fan motor and blower in an off state during the steam pulsing whereby no air is supplied to the drum during steam pulsing; and,
the main controller operating the fan motor and blower in the on state during the cool down cycle to supply said ambient air.

15. The clothes dryer of claim 1 wherein, prior to the de-wrinkle course, the main controller operates the dryer to complete a dry cycle.

16. The clothes dryer of claim 1 wherein, prior to the first steam pulse, the main controller operates the heater to supply heated air into the drum.

17. The clothes dryer of claim 1 further comprising a moisture sensor located within the drum for sensing moisture content of the articles and generating a moisture content value related thereto, wherein the main controller is operable with the moisture sensor whereby the main controller de-energizes the heater to terminate the final pulse of heated air once the moisture sensor detects, using the moisture content value, a predetermined level of dryness for the clothing articles.

18. The clothes dryer of claim 1 wherein after the final pulse, the main controller operates the dryer to enter a cool down cycle wherein the main controller operates the blower to supply ambient air to the drum and the motor to rotate the drum until the cool down cycle ends.

19. The clothes dryer of claim 1 further comprising:
a fan motor for rotating the blower, the fan motor being independently operable of the motor for rotating the drum;
the main controller in response to the de-wrinkle course being selected, operating the fan motor and the blower in an on state to supply air to the drum during pulsing of heated air; and
the main controller operating the fan motor and blower in an off state during the steam pulsing whereby no air is supplied to the drum during steam pulsing.

20. The clothes dryer of claim 18 further comprising:
a fan motor for rotating the blower, the fan motor being independently operable of the motor for rotating the drum;
the main controller in response to the de-wrinkle cycle being selected, operating the fan motor and blower in an on state to supply heated air to the drum during pulsing of heated air;
the main controller operating the fan motor and blower in an off state during the steam pulsing whereby no air is supplied to the drum during steam pulsing; and,
the main controller operating the fan motor and blower in the on state during the cool down cycle to supply said ambient air.

21. The clothes dryer of claim 19 wherein the motor comprises:
a reversible motor able to rotate the drum in a first rotation direction and in a second rotation direction opposite the first;
the main controller, during the de-wrinkle cycle, energizing the motor to rotate the drum in the first rotation direction for a first rotation period and then de-energizing the motor to reduce drum angular velocity, and then energizing the motor to rotate the drum in the second rotation direction for a second rotation period; and
the main controller alternating between the first and the second rotation direction throughout the de-wrinkle cycle and reducing drum angular velocity prior to changing rotation direction.

22. The clothes dryer of claim 19 wherein the de-wrinkle course may be a selected one of an operational course for eliminating wrinkles after a drying operation has been completed and an independent course for eliminating wrinkles in the clothing articles.

23. The clothes dryer of claim 19 wherein the duration of the final pulse is a selected one of a predetermined time and a duration according to the dried state of the clothing articles.

24. The clothes dryer of claim 19 wherein the steam is supplied to the dryer drum via a steam supply line in communication with the steam generating device and with the drum.

25. The clothes dryer of claim 19 wherein, prior to the first steam pulse, the main controller operates the heater to supply heated air into the drum.

26. The clothes dryer of claim 19 further comprising a moisture sensor located within the drum for sensing moisture content of the articles and generating a moisture content value related thereto, wherein the main controller is operable with the moisture sensor whereby the main controller de-energizes the heater to terminate the final pulse of heated air once the moisture sensor detects, using the moisture content value, a predetermined level of dryness for the clothing articles.

27. The clothes dryer of claim 19 wherein after the final pulse, the main controller operates the dryer to enter a cool down cycle wherein the main controller operates the blower to supply ambient air to the drum and the motor to rotate the drum until the cool down cycle ends.

28. A method for reducing or eliminating wrinkles in clothing articles in a clothes dryer comprising the steps of:
determining that a de-wrinkle course has been selected;
supplying a plurality of pulses of steam of at least one first predetermined time to the clothing articles in response to it being determined that a de-wrinkle course has been selected; and,
supplying a pulse of heated air to the clothing articles after each steam pulse where each pulse of heated air supplied between steam pulses is an intermediate pulse of at least one second predetermined time to reduce condensation in the dryer and the pulse of heated air after the last steam pulse is a final pulse of a duration to dry the clothing.

29. The method as in claim 28 further comprising the step of alternating drum rotation direction throughout the de-wrinkle cycle, between a first rotation direction for a first rotation period, and a second rotation direction opposite the first rotation direction for a second rotation period, wherein drum angular velocity is reduced prior to changing rotation direction.

30. The method as in claim 28 wherein the step of determining that a de-wrinkle course has been selected further comprises selecting one of an operational course for eliminating wrinkles after a drying operation has been completed and an independent course for eliminating wrinkles in the clothing articles.

31. The method as in claim 28 further comprising the step of completing a dry cycle prior to the step of supplying a plurality of pulses of steam.

32. The method as in claim 28 further comprising the step of supplying heated air to the drum prior to the step of supplying the plurality of pulses of steam.

33. The method as in claim 28 further comprising sensing the moisture level of the load during the duration of the final pulse, and in response to sensing a predetermined level of dryness in the load, terminating the final pulse of heated air.

34. The method as in claim 28 further comprising the step of supplying no air to the drum during the steam supplying step.

35. The method as in claim 28 further comprising the steps of:
supplying no air to the drum during the steam supplying step; and
a cool down cycle comprising supplying ambient air to the drum while continuously rotating the drum for a third predetermined time.

36. The method as in claim 29 further comprising the step of completing a dry cycle prior to the step of supplying a plurality of pulses of steam.

37. The method as in claim 29 further comprising the step of supplying heated air to the drum prior to the step of supplying the plurality of pulses of steam.

38. The method as in claim 29 further comprising sensing the moisture level of the load during the duration of the final pulse, and in response to sensing a predetermined level of dryness in the load, terminating the final pulse of heated air.

39. The method as in claim 29 further comprising the step of supplying no air to the drum during the steam supplying step.

40. The method as in claim 29 further comprising the steps of:
supplying no air to the drum during the steam supplying step; and
a cool down cycle comprising supplying ambient air to the drum while continuously rotating the drum for a third predetermined time.
